(19) United States
(12) Patent Application Publication
(10) Pub. No.: US 2019/0028293 A1
(43) Pub. Date: Jan. 24, 2019

(54) System for Controlling and Monitoring Connected Components

(71) Applicants: David R. Hall, Provo, UT (US); Jerome Miles, Spanish Fork, UT (US); Christopher Jones, Spanish Fork, UT (US); Casey Webb, Spanish Fork, UT (US)

(72) Inventors: David R. Hall, Provo, UT (US); Jerome Miles, Spanish Fork, UT (US); Christopher Jones, Spanish Fork, UT (US); Casey Webb, Spanish Fork, UT (US)

(21) Appl. No.: 15/955,916

(22) Filed: Apr. 18, 2018

Related U.S. Application Data
(63) Continuation-in-part of application No. 62/534,321, filed on Jul. 19, 2017.

(51) Int. Cl. H04L 12/28

(52) U.S. Cl. CPC H04L 12/2814; H04L 2012/2841; H04L 12/2809; H04L 12/2829

(57) ABSTRACT

A system for controlling connected components is disclosed. Multiple components, each connected to a network, and at least some of which are mounted overhead are connected to a hub that controls and monitors the components. The hub is connected to the network and contains; a processor; non-transitory memory; a user interface; a microphone; and at least one remote control device. The hub is capable of receiving and implementing instructions via voice commands, via a remote control device, and/or via the user interface. A method for implementing the system is also disclosed.

### CROSS-REFERENCE TO RELATED APPLICATIONS

This application is a continuation-in-part of U.S. Provisional Application 62/534,321 filed Jul. 19, 2017, the entire contents of which are incorporated herein by reference.

### TECHNICAL FIELD

This invention relates generally to the Internet of Things and more specifically to smart home devices.

### BACKGROUND

The garage is a wonderful place, the utilitarian space of a home where multitudes of different purposes meet and can be accomplished. Some garages are the storage areas, and accumulation of life and its artifacts. Some garages are the workshops where heirlooms that will be passed down for generations are crafted. No matter the use, garages need help to keep working efficiently. Smart devices offer the promise of personal. Many improvements and developments have been made in the field of smart home devices. However, interoperability is a persistent problem. Additionally, because of the variety of sources of smart home devices, many computer-run applications, such as smart phone apps, are required to run all the various devices. This can become particularly cumbersome. Thus, there is room for improvement in the field of smart home devices.

### SUMMARY

In a first aspect, a system for controlling connected components is disclosed. Multiple components, each connected to a network, and at least some of which are mounted overhead are connected to a hub that controls and monitors the components. The hub is connected to the network and contains; a processor; non-transitory memory; a user interface; a microphone; and at least one remote control device. The hub is capable of receiving and implementing instructions via voice commands, via a remote control device, and/or via the user interface.

In a second aspect the hub is configured to identify users limit control of certain of the components to a predetermined set of users. For example, it may limit use of a dangerous tool to users above a certain age, or to users who have been trained on the tool. The same can be done for an expensive or delicate tool. The hub is capable of implementing instructions received from the personal control device when the user is physically away from the hub if certain conditions for remote operation are met.

Further aspects and embodiments are provided in the drawings, detailed description and claims.

### BRIEF DESCRIPTION OF THE DRAWINGS

The following drawings are provided to illustrate certain embodiments described herein. The drawings are merely illustrative, and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a view of the system mounted overhead in a garage.

FIG. 2 is a system diagram of the system including access to a cloud-based server.

FIG. 3 is a second system diagram of the system.

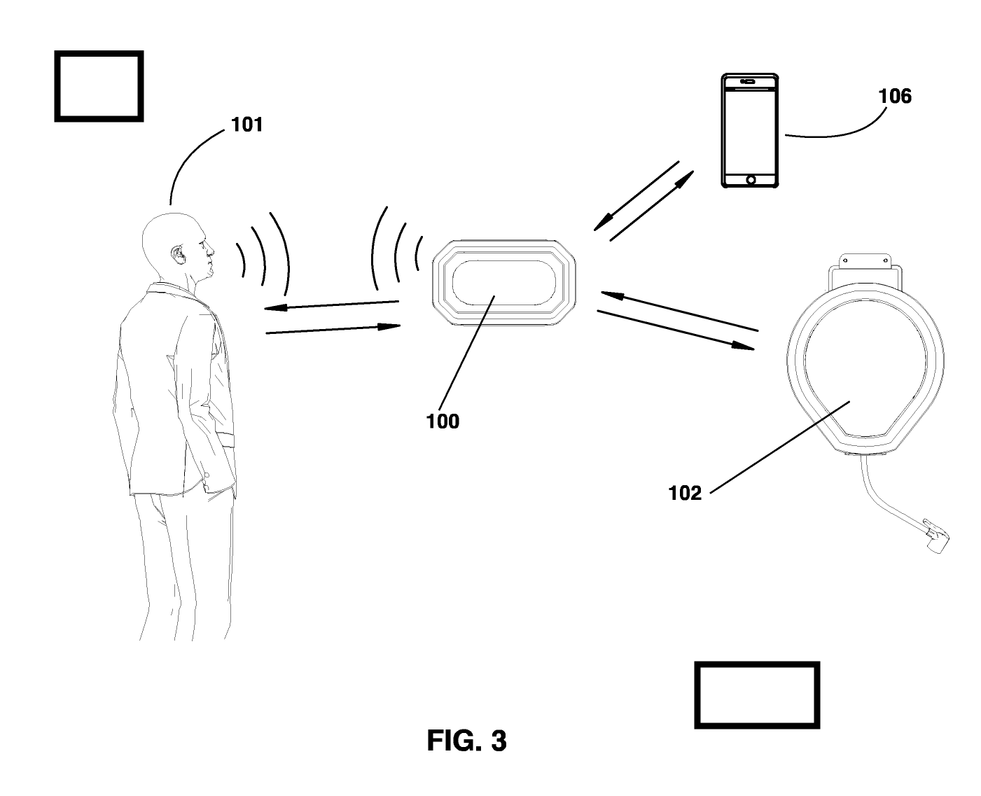

FIG. 4 is a view of the system mounted in a garage.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

This application incorporates by reference all the subject matter disclosed in the following references: US Patent Application No. 20150284221A1 by David R. Hall et al., filed Apr. 3, 2014 and entitled “Compact Motorized Lifting Device”; US Patent Application Serial No. 20160236916A1 by David R. Hall et al., filed Apr. 27, 2016 and entitled “Multiple Motorized Lifting Devices Mounted to a Structure”; U.S. Pat. No. 9,860,361 by David R. Hall et al., filed Jan. 24, 2017 and entitled “Wirelessly Controlled Inflator”; U.S. patent application Ser. No. 15/426,556 by David R. Hall et al., filed Feb. 7, 2017 and entitled “Compact Inflator”; U.S. patent application Ser. No. 15/441,928 by David R. Hall et al., filed Feb. 24, 2017 and entitled “Intelligent Current Limiting to Enable Chaining of AC Appliances”; U.S. patent application Ser. No. 15/443,312 by David R. Hall et al., filed Feb. 27, 2017 and entitled “Intelligent Current Limiting to Enable Chaining of DC Appliances”; U.S. patent application Ser. No. 15/443,434 by David R. Hall et al., filed Feb. 27, 2017 and entitled “Intelligent Current Limiting to Enable Chaining of AC and DC Appliances”; U.S. patent application Ser. No. 15/487,999 by David R. Hall et al., filed Apr. 14, 2017 and entitled “Overhead Mounting System”; U.S. patent application Ser. No. 15/488,860 by David R. Hall et al., filed Apr. 17, 2017 and entitled “Overhead Mounting System for Daisy-Chained Devices.”

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “component” is meant to refer to all AC electrical appliances, DC electrical appliances, power tools, accessories and other objects that connect to the system, or mount to the overhead mounting system.

As used herein, “personal control device” is meant to refer to devices such as smart phones; tablet computing devices, such as iPad or Galaxy Tab; laptop computers; or other computing devices.

As used herein, “digital assistant” is meant to refer to computing devices including but not limited to: Amazon Echo, Amazon Echo Dot, Google Home, Google Home Mini, Nest, and HomePod.

As used herein, “hub” is meant to refer to a computing device that contains: a processor; non-transitory memory; a user interface; a microphone and is adapted to connect to a network and other devices, the connections can be wired or wireless.

The system connects the various components of the system together. They are connected together for receiving power and for communication and control. In certain embodiments this communication occurs directly between the hub and individual components. In other embodiments this communication occurs via a network, such as a cloud-based network. In one embodiment such a network includes a Bluetooth mesh network, such as in embodiment wherein the devices utilize Bluetooth transceivers. Various components integrated into the system are interconnected in a power supply scheme. Additionally, in one embodiment various components integrated into the system are integrated by an overhead mounting system.

In one embodiment, one or more components is incorporated with the system. Such components include, but are not limited to: a motorized lifter; a track-mounted inflator; a stud-finding device; a vacuum; a power supply device; a spotlight; a fan; a laser park assist; a security camera; a retrofittable motor for opening a window; a proximity sensor; and/or one or more smart toys such as a soft dart shooter. Each component includes one or more hardware processors and hardware memory, and one or more transceivers. In one embodiment, components additionally include one or more microphones and one or more speakers. A user operates such microphone containing components by providing an auditory command. The auditory command is received by the speaker associated with the respective component and is translated into machine-executable instructions by the processors. Each device recognizes particular auditory commands, thereby obviating the need for a device identifier as part of the command in environments with two or more voice-controlled smart devices. For example, the system includes a motorized lifter and an inflator. The lifter stores programming that recognizes lifting-related auditory commands, such as “raise,” “lift,” and/or “lower.” The inflator stores programming that recognizes inflator-related auditory commands, such as “psi,” numbers, and/or names of inflatable objects such as “bike tire” or “football.” The microphones of each device, is always listening, and the processors only react when a recognized auditory signal is received. Similarly, each device communicates with a user by audible signals, such as by a voice stating, “maximum height reached,” or “that operation is not allowed at this time.”

In certain embodiments, the hub receives all voice commands for any component, processes the voice commands and transmits the voice commands to a cloud-based server for interpretation of the digitally-processed voice command into instructions, including identification of a device for which the command is intended and a function to be executed by the device. The cloud-based server then forwards the instruction to the intended device. Alternatively, the hub locally stores the instructions for, and identification of, each interconnected smart device. Processing of the voice command is performed locally on the hub, and interpretation and transmission of the instructions also occurs locally on the hub. The hub directly transmits operation instructions to the intended device. In some embodiments, voice command instructions include only commands to perform certain data processing and storage on the hub and/or cloud-based server. For example, to revoke an individual's permissions for operating a single or all networked devices, an administrative user says “Revoke Jeff's permissions for operating all networked devices.” The hub and/or cloud-based server then removes from memory any stored recognition of the designated user's voice and permission to access the system by voice of the now non-permitted user.

In certain embodiments, the system is operated through an application, with a user interface, on a personal control device, Such as; a smart phone, a tablet, or any of a variety of personal computers or other computing devices. The personal control device allows the user to manually control any of the components. The user controls the components by manually inputting commands, such as commands provided through the user interface of an application associated with the entire system of connected components. By connecting all components together through the hub all products are able to communicate with each other through the hub. For example, a user could create settings that will turn on the connected fan every time the lights are turned on when the heat sensor on the fan identifies the temperature is above a predetermined threshold. Alternatively a setting could be created that when the lights are turned on the fan is turned on as long as the motion sensor determines that there is movement. Connecting all components to the hub allows a user to determine which products are connected to the system. The user can see power consumption on the entire system and for each component individually since all products will report to the hub.

In certain embodiments, the system includes components that include batteries. Included in the information sent to the hub are battery levels on those components and also charging status. In some embodiments a user programs an alert to notify a user to a dying battery.

In one embodiment, the hub has an integrated touch enabled control screen. This screen is able to run the full system app so a user does not have to pull their personal control device out to use the products. In one embodiment the hub is android based so all android apps can be downloaded and used just as you would on a phone or tablet. In another embodiment, the control screen is detachable from the hub body allowing the user to move around her garage holding the control screen. In an alternative embodiment the hub docks into a wall-mounted charging dock instead of attaching to the overhead mounting system. To satisfy safety requirements of unattended operation, which require visible and audible alerts that the system will be performing actions such as closing a garage door, lowing a winch, or other actions that could injure a person unaware of the action being taken, the docking station for the touch enabled control screen is equipped with speakers and lights. In another embodiment the speakers and lights are integrated into the portable control screen of the hub instead of only on the wall mount. Preferably, the lights have a battery back up allowing for emergency lighting in a power outage situation. Some garages do not have windows and would be very dark and possibly dangerous in a power outage situation.

In another embodiment, the user also provides auditory commands that are picked-up by the personal control device, processed and translated into one or more machine-executable commands, and transmitted via to the respective smart device. Voice control is built into the hub, a microphone or array of microphones on the hub listens for and process voice commands, the microphones in the hub can be supplemented by microphones placed at other locations in the garage thus increasing the range of use for voice control and the voice commands. The microphones in the hub could be replaced and/or supplemented by microphones placed in each product and as the user's product line grows so does their microphone array. The hub could be equipped with human detection sensors to further supplement the other system motion, human, IR sensors.

It is more convenient and efficient to centralize voice command processing. For example, in another embodiment, each component includes a microcontroller with fixed firmware. The firmware is often stagnant, responding only to manual commands via manual switches on the device, or commands received via the transceiver. In certain embodiments, the commands are transmitted over the network from the cloud-based server, which is dynamically programmable by a user, such as via a user application installed on the user control device and/or the cloud-based server. The cloud-based server also stores and executes a voice recognition protocol, which enhances the security and efficiency of the system by preventing unauthorized use. A user provides an auditory command, which is digitized and forwarded to the cloud-based server. The cloud-based server performs an authentication procedure, such as text-dependent or text-independent speaker recognition, and then performs the task associated with the command, such as updating an operation schedule for a security camera, or may be a command directed for a specific smart device, such as inflating an object to a specified psi.

In some embodiments, the components have limited voice recognition capabilities, such as speech recognition of specific words and/or phrases, and the cloud-based server performs more complicated and robust voice recognition, such as speaker recognition and natural language processing. When an auditory command is received by; a smart device, the voice control module, or the user device, threshold filtering is performed to determine whether the command falls into the limited tier of recognition or the robust tier of recognition. If the command falls into the limited tier, the command is executed by the device upon recognition or, if not received by the device for which the command is intended, is transmitted via the network directly to the intended device. If the command falls in to the robust tier, the command is forwarded to the cloud-based server and/or the hub for processing and/or execution of the command. After being processed, the command is transmitted to the designated device for execution.

In various embodiments, multiple microphones, each corresponding to different devices, listen for auditory commands from a user. For example, one of the components, the hub, and the user control device each have a microphone. Each microphone receives auditory input from the user. The received inputs are forwarded to the hub, which processes the auditory inputs to form a unitary input. This improves the accuracy of translating auditory inputs into commands. Additionally, it provides a means for safety during remote actuation. If the user control device only receives auditory input, this indicates to the hub that the user is outside a range of the smart device and the hub, so that safety mechanisms such as alarms and lights are implemented to ensure safe operation of the smart device.

In specific embodiments, each component recognizes a limited number of auditory inputs corresponding specifically to that device. If a smart device receives an auditory input that is not recognized, it digitally encodes that auditory input according to a pre-programmed method, such as by assigning the differences between neighboring frequencies particular bit strings, and transmits via an RF signal the encoded command. Each component, in this embodiment, is programmed to recognize particular auditory command encodings, and listens for such encodings via its transceiver. When a code that is recognized is received, the device processes the encoding to determine what the code is and then executed the command associated with the encoding.

In some embodiments, the system requires authentication from a user profile, before any component is ready for use. In certain embodiments each component includes firmware that requires, before the device is operated, authentication from a user profile. Once the authentication is received, the device is fixed to that profile such that it will not operate unless the authentication is verified. This serves as a theft deterrent by only allowing use by connection to the cloud-based server and prohibiting use of unauthorized users not associated with the original authentication profile. Multiple voice profiles associated with an authenticated profile such that speaker and/or speech recognition of multiple users is permitted.

The ability to regulate which components are in use, in some embodiments, is a safety feature for the physical well being of the user as well as a safety feature against unauthorized use. When setting up the system a user creates profiles for all those who will have access to the system and its components. The system allows the creation of individualized profiles with individualized permissions for accessing and using the components of the system. The hub stores these profiles and uses them to regulate access to the system and its components.

In some embodiments, the system includes an application and user interface for use on a personal control device. The app is one method for a user to interact with the system including; allowing users to; be identified, control components attached to the system, monitor use of each component, program recurring actions by the components, establish protocols for components to follow.

In certain embodiments, a user operates various components when physically away from the system, the user accesses the system via their user control device, which connects to the network the system is connected to. In certain embodiments, only certain components or certain combinations of components are capable of being accessed when the user is physically away from the system. For example, lifting devices are not enabled for remote use, the user must physically be in the location of the system to activate any lifting device, however if the user also has a camera connected to the system, and the camera is activated, and sends a live feed to the user's personal control device, the lifting device can also be activated as the user can watch the lifting or lowering of the lifting device on their user control device. Another example; is that of a charging device connected to the system. When connected to the system the user can see the status and function of the charging device, this live report enables the user to activate the charging device.

In certain embodiments, the system components interconnect using a Bluetooth mesh. Control of the system is concentrated in a user application accessed via the user control device and stored on the cloud-based server. The microphones allow the system to be aware of all activities performed in the vicinity of the integrated devices. The system also continuously collects data on a user's activities. This data is aggregated across many users. For example, the system recognizes; a motorized lifter supports a bicycle, when a user says, “I'm going to put Barbara's bike on the lifter rack.” The system recognizes patterns when the user utilizes the bike, such as a yearly, seasonal, monthly, weekly and/or daily pattern. For example, the system recognizes the user is lowering the bike every weekday morning and raising it every weekday evening. The system further recognizes that the user always listens to an audio book after lowering the bike, and that the user always listens to the audio book for an hour before lifting the bike. The system will then provide a prompt to the user via the user control device to start the audio book automatically after lowering the bike and an hour before the bike is typically raised.

The system monitors how often a particular product is used, and detects changes in usage patterns. The system, for example, notices a drop in the frequency with which the bike is lowered, and provides a prompt to the user encouraging the user to use the bike or asking if products are needed to repair the bike. The system also monitors how long a user has owned and/or used a product, and recommends replacement or upgrading of that product after a specified amount of time.

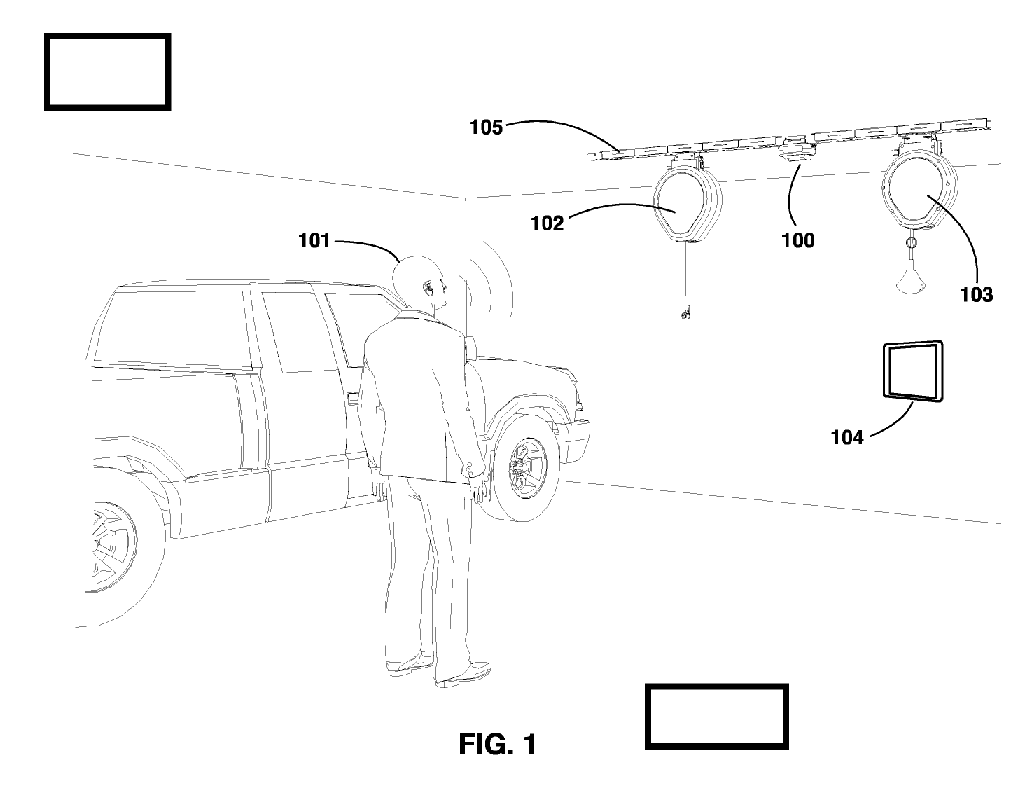

Now referring to FIG. 1, the hub 100 is attached to the overhead mounting system 105. An air compressor 102 and an extension cord 103 are also attached to the overhead mounting system. The hub and the components are connected wirelessly; in this instance the connection is a Bluetooth mesh network. The hub is also connected to a home Wi-Fi network, allowing the hub to connect to a cloud-based server. The hub 100 is connected to the air compressor 102 and extension cord 103. The hub 100 is designed to authenticate a user 101, in the current aspect the authentication is through voice recognition. The user's 101 voice is connected to the user's profile, which stores permissions for what components a user is permitted to use. Once the user 101 has been authenticated the hub 100 imports voice commands through at least one microphone, the voice commands are processed on the hub 100, and the command is relayed to whichever device is being instructed to perform a task. For example the user 101 states, “inflate bicycle tire to 35 psi.” The microphone on the hub 100 picks up the auditory commands, processes them and sends instructions to the air compressor 102. The air compressor then inflates the bicycle tire to 35 psi. In certain embodiments, a touch screen control panel 104 accompanies the hub 100. The touch screen control panel also has a user interface through which instructions are issued through the hub 100 to the connected components 102 and 103. In this case the user will input, “inflate bicycle tire to 35 psi” in the user interface on the touch screen control panel 104. The hub will receive the instruction and send the instruction to the inflator 102. In certain embodiments the touch screen control panel 104 is equipped with a camera. The camera aids in allowing components to be used when the user 101 is not physically present. The camera is equipped to send a live feed to the user's personal control device allowing the user to verify that it is safe to operate the components. The camera is also designed to scan QR codes, so that new components can connect to the hub 100 and the Bluetooth network.

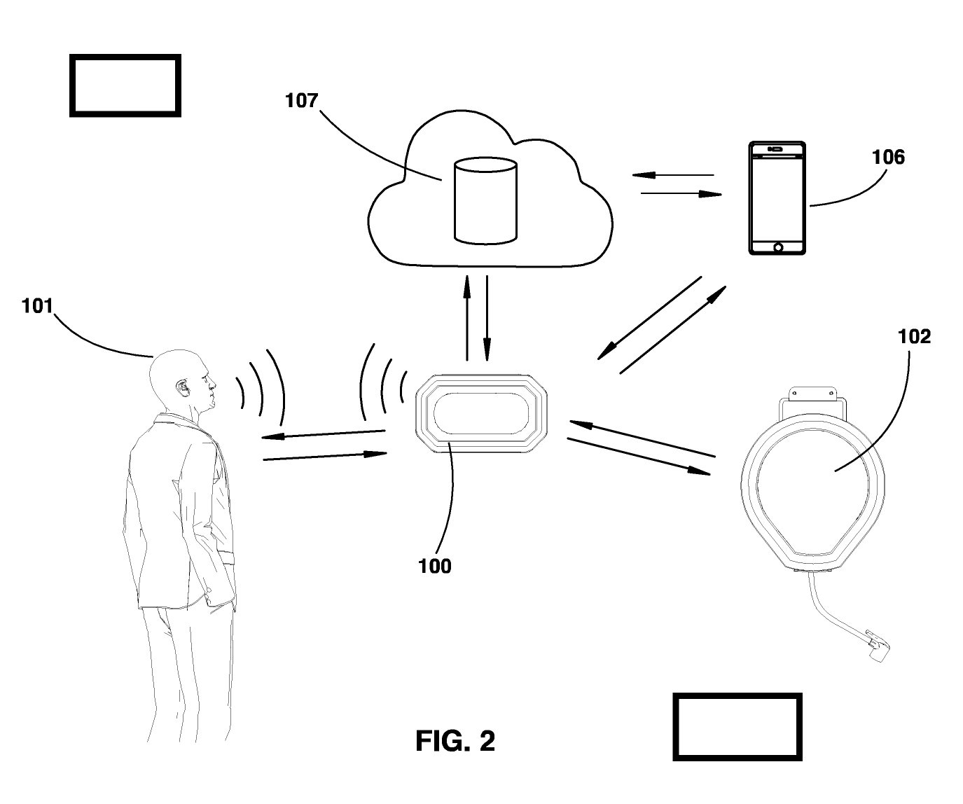

Now referring to FIG. 2, the hub and the components are connected wirelessly; in this instance the connection is a Bluetooth mesh network. The hub is also connected to a home Wi-Fi network, allowing the hub to connect to a cloud-based server. The hub 100 receives a voice command from the user 101 and interprets the voice commands and converts them into instructions. The instructions include identification of the device, the inflator 102, and the function to be executed by the inflator 102. For example, user 101 gives a voice command to, “inflate bike tire to 35 psi.” The hub 100 receives the command, interprets the voice command, and converts the command into executable instructions. The instructions are transmitted to the inflator 102, where the inflator 102 executes the instructions and inflates the bike tire to 35 psi. In another embodiment the user employs a user interface on the personal control device 106 and issues commands or instructions through this user interface. The user would input inflate bicycle tire to 35 psi in the user interface, the personal control device 106 would send the instruction to the hub 100, which then sends it to the component. In another embodiment the user employs a user interface on the personal control device 106 and issues commands or instructions through this user interface. The user would input “inflate bicycle tire to 35 psi” in the user interface; the personal control device 106 connects to the cloud-based server and sends instructions to the hub 100 through the cloud-based server. In this way the user 101 is able to direct the components to complete tasks when physically away from the hub and components. In this case the user will input, “inflate bicycle tire to 35 psi” in the user interface on the personal control device 106, the command will be sent to the cloud-based server, which will forward the command to the hub, the hub will then send the instruction to the inflator. When the command is issued to the inflator, a sensor will verify that the inflator 102 is attached to a valve, if the inflator is not attached a message will be returned in the way the instruction was issued, therefore when the instruction was a voice command the response will be an audible response, when the command is input via the user interface on the personal control device a message will return to the user interface stating that there is no tire attached.

In certain embodiments, the system is configured to allow the user to activate components when physically removed from the system. For example, the system has a light attached to the system; the user utilizing the user interface on their personal control device issues the instruction to turn on the light. The personal control device sends this instruction to the cloud-based server 107, which sends it to the hub 100 through the network, which sends the instruction to the light, through the Bluetooth connection. In another embodiment the system will prevent the commanded action from taking place. For example, the system is equipped with a device for lifting and lower bikes, the user, who is physically removed from the system, through the user interface on their personal control device instructs that the bikes be lowered. The instruction will be sent from the personal control device to the cloud-based server, where the request will be denied. In another embodiment, the use has the bike lifter and a camera installed in the system. The user, who is physically removed from the system, instructs that the bike lifter lower the bikes. The attached camera sends a live video to the user control device, via the hub and cloud-based server. The instruction is sent to the cloud-based server 107, and on to the hub 100, which forwards the instruction to the bike lifter; the bike lifter lowers the bike. When the instructions for actions come to the hub 100 via the cloud-based server 107, in other words, when the user is not physically present there are conditions that must be met for the instructed action to be fulfilled such as a camera being attached to the system and able to send a live feed to a user's personal control device. When the instructions come to the hub 100 via Bluetooth or auditory commands there are different parameters that must be met for the instructions to be fulfilled.

In another embodiment, the hub 100 locally stores the instructions for, and identification of, each interconnected component. The hub directly transmits operation instructions to the intended device, the inflator 102. For example, user 101 gives a voice command to, “inflate bike tire to 35 psi.” The hub 100 receives the command, processes the command, interprets the voice command, and converts the command into executable instructions. The instructions are transmitted back to the inflator 102, where the inflator 102 executes the instructions and inflates the bike tire to 35 psi. In another embodiment the user employs a user interface on the personal control device 106 and issues commands or instructions through this user interface. The user would input inflate bicycle tire to 35 psi in the user interface, the personal control device would send the instruction to the hub, which then sends it to the component. When there is no connection to a cloud-based server the user cannot operate the components when physically away from the hub and the system. In another embodiment, the interconnected components each contain microphones and a microphone array is created where the user can issue voice commands that are picked up by any of the components, this microphone array aids in properly processing instructions and ensuring that the task the user is intending to take place does in fact take place.

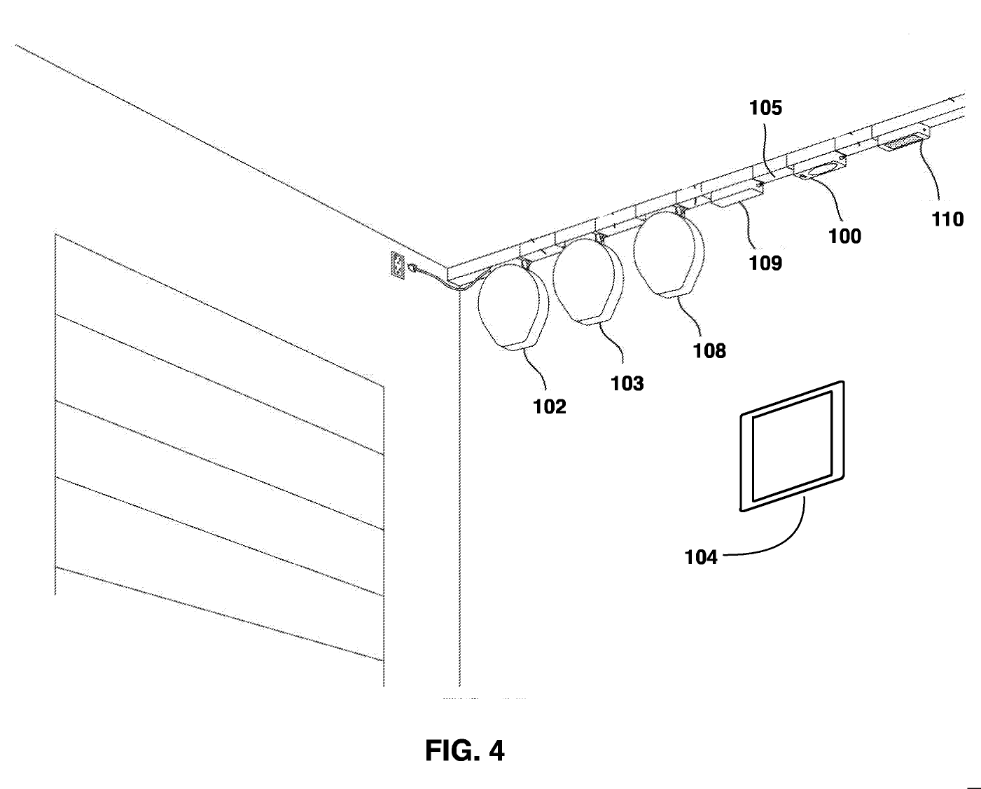

FIG. 4 shows the hub 100 and components attached to an overhead mounting system 105. The components include an inflator 102, a power cord 103, a battery charger 108, a light 109, and a camera 110. The touch screen control panel 104 is attached to the wall. In some embodiments the touch screen control panel 104 is fixed in one place. In other embodiments the touch screen control panel 104 attaches to the wall as part of a docking station, when configured as part of a docking station the touch screen control panel 104 is removable from the docking station and can be carried around by the user. In certain embodiments safety features are included in the touch screen control panel 104 so that the user can implement tasks when physically away from the hub 100 and components, these safety features include an audible alarm, and flashing lights. These safety features are to let anyone in the vicinity of the hub 100 and the components know that some of the components will be operating. The hub 100 is configured so that most components can only be operated after a user has been authenticated, this gives users control over access to the components, however, in some circumstances it would be beneficial to allow general access to certain components. For example, it is beneficial to allow all who enter a garage to be able to see, to ensure that anyone entering the garage can see the hub can be configured to turn on the lights such as light 110 attached overhead, anytime it recognizes the word lights.

In certain embodiments, a touch screen control panel 104 accompanies the hub 100. The touch screen control panel also has a user interface through which instructions are issued through the hub 100 to the connected components 102 and 103. In this case the user will input, “inflate bicycle tire to 35 psi” in the user interface on the touch screen control panel 104. The hub will receive the instruction and send the instruction to the inflator 102. In certain embodiments the touch screen control panel 104 is equipped with a camera. The camera aids in allowing components to be used when the user 101 is not physically present. The camera is equipped to send a live feed to the user's personal control device allowing the user to verify that it is safe to operate the components. The camera is also designed to scan QR codes, so that new components can connect to the hub 100 and the Bluetooth network.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for controlling components comprising
multiple components, each connected to a network, and at least some of which are mounted overhead;
a hub for controlling and monitoring the components, the hub connected to the network and comprising;
a processor;
non-transitory memory;
a user interface;
a microphone; and
at least one remote control device; and
wherein the hub is capable of receiving and implementing instructions via voice commands, via a remote control device, and/or via the user interface.

2. The invention of claim 1, wherein the hub is configured to identify users and wherein control of certain of the components is limited to a predetermined set of identified users.

3. The invention of claim 1, wherein the hub is capable of implementing instructions received from the personal control device when the user is physically away from the hub if certain parameters are met.

4. The invention of claim 3, wherein one of the parameters for remote use of the system is a live video feed to the personal control device.

5. The invention of claim 3, wherein one of the parameters for remote use of the system is a live status and function report of the chosen component.

6. The invention of claim 1, wherein the remote control device is a touch enabled control screen.

7. The invention of claim 6, wherein the touch enabled control screen is mounted on a wall.

8. The invention of claim 6, wherein the touch enabled control screen is removable from a wall mounted dock.

9. The invention of claim 6, wherein the touch enabled control screen includes a camera.

10. The invention of claim 9, wherein the camera is capable of scanning QR codes.

11. The invention of claim 10, wherein the scanned QR codes link components to the hub.

12. The invention of claim 2, wherein users are identified through voice recognition.

13. The invention of claim 2, wherein users are identified through the interface on the personal control device.

14. The invention of claim, wherein users are identified through face recognition.

15. A method for creating a smart garage system comprising:
providing multiple components, each connected to a network, and at least some of which are mounted overhead;
providing a hub for controlling and monitoring the components, the hub connected to the network and comprising;
a processor;
non-transitory memory;
a user interface;
a microphone; and
at least one remote control device; and
wherein the hub is capable of receiving and implementing instructions via voice commands, via a remote control device, and/or via the user interface.

16. The invention of claim 15, wherein the hub is capable of implementing instructions received from the personal control device when the user is physically away from the hub if certain parameters are met.

17. The invention of claim 15, wherein one of the parameters for remote use of the system is a live video feed to the personal control device.

18. The invention of claim 15, wherein one of the parameters for remote use of the system is a live report showing the status and function of the chosen component.

19. The invention of claim 1, wherein control of certain components is not restricted to identified users.

20. The invention of claim 19, wherein the component is a light.
